(19) United States
(12) Patent Application Publication
(10) Pub. No.: US 2025/0375929 A1
(43) Pub. Date: Dec. 11, 2025

(54) METHODS OF FORMING RIGID LOGOS WITH FLEXIBLE BACKINGS

(71) Applicant: PLUME DESIGN, INC., Palo Alto, CA (US)

(72) Inventors: Hao-Hsiu HUANG, Cupertino, CA (US); Meng-Jung CHUANG, Taipei City (TW); Ming-Tsung SU, Taipei City (TW)

(21) Appl. No.: 18/736,723

(22) Filed: Jun. 7, 2024

(51) Int. Cl. B29C 45/16; B22D 17/00; B29C 71/00; B29L 31/00

(52) U.S. Cl. CPC B29C 45/1657; B22D 17/00; B29C 71/00; B29L 2031/722

(57) ABSTRACT

Methods of forming apparatuses may include forming a rigid logo having a logo shape protruding from a rigid substrate, forming at least one aperture in a flexible backing, positioning the logo shape in the at least one aperture to protrude from a front surface of the flexible backing through the at least one aperture, and abutting a back surface of the flexible backing against the rigid substrate. Various other related methods and apparatuses are also disclosed.

### BACKGROUND

Logos can be used for brand and quality identification of products and consumer goods. Some logos can be formed on products with a flexible backing, such as leather, and a rigid logo emblem, such as from metal and/or hard plastic. In some cases, the logo emblem is adhered to the flexible backing and/or pinned to the flexible backing (e.g., with an integral pin or other protrusion).

### SUMMARY

In some aspects, the techniques described herein relate to a method of forming an apparatus. The method may include: forming a rigid logo having a logo shape protruding from a rigid substrate; forming at least one aperture in a flexible backing, the at least one aperture having an aperture shape corresponding to the logo shape; positioning the logo shape in the at least one aperture to protrude from a front surface of the flexible backing through the at least one aperture; and abutting a back surface of the flexible backing against the rigid substrate.

In some aspects, forming the rigid logo may include performing an injection molding process to form the rigid logo and the rigid substrate. Prior to positioning the logo shape in the at least one aperture, the logo shape may be polished. The back surface of the flexible backing may be bonded to the rigid substrate with an adhesive. The rigid substrate may be formed to have a rough surface to improve the bonding between the back surface of the flexible backing and the rigid substrate. The logo shape and/or the rigid substrate may include a metal material. The logo shape and the rigid substrate may form a unitary, integral body of material. The flexible backing may include a real or artificial leather material. Forming the at least one aperture in the flexible backing may include die-punching the flexible backing. Forming the rigid logo may include forming the logo shape to have at least one feature with a feature width of less than 2 mm and forming at least one aperture may include forming a corresponding aperture portion with an aperture width of less than 2 mm.

In some aspects, the techniques described herein relate to another method of forming an apparatus. The method may include: cutting a flexible backing of a real or artificial leather material to form at least one aperture in the flexible backing, the at least one aperture having an aperture shape corresponding to a logo shape of a metal logo; positioning the logo shape in the at least one aperture to protrude from a front surface of the flexible backing through the at least one aperture; and bonding a back surface of the flexible backing to a metal substrate of the metal logo, such that the logo shape protrudes from the metal substrate.

In some aspects, a metal injection molding process may be performed to form the metal logo having the logo shape protruding from the metal substrate. A surface of the metal substrate may be etched to improve the bonding between the back surface of the flexible backing and the metal substrate.

In some aspects, an apparatus described herein may include: a rigid logo having a logo shape protruding from a rigid substrate; and a flexible backing including at least one aperture having an aperture shape corresponding to the logo shape, wherein the logo shape is positioned in the at least one aperture and protrudes from a front surface of the flexible backing through the at least one aperture, and a back surface of the flexible backing abuts against the rigid substrate.

In some aspects, the back surface of the flexible backing may be bonded to the rigid substrate with an adhesive. The rigid logo may be formed of a metal material. The logo shape and the rigid substrate may be portions of a unitary, integral body of material. The flexible material may include a real or artificial leather material. The logo shape may have at least one feature with a feature width of less than 2 mm and the at least one aperture includes a corresponding aperture portion with an aperture width of less than 2 mm.

### BRIEF DESCRIPTION OF THE DRAWINGS

FIG. 1 is a plan view of a flexible backing for an apparatus that includes a rigid logo, according to at least one embodiment of the present disclosure.

FIG. 2 is a perspective view of a rigid logo, according to at least one embodiment of the present disclosure.

FIG. 3 is a perspective view of an apparatus that includes a flexible backing and a rigid logo, according to at least one embodiment of the present disclosure.

FIG. 4 is a partial cross-sectional view of the apparatus of FIG. 3, taken from line A-A of FIG. 3, according to at least one embodiment of the present disclosure.

FIG. 5 is a flow diagram illustrating a method of forming an apparatus, according to at least one embodiment of the present disclosure.

FIG. 6 is a flow diagram illustrating a method of forming an apparatus, according to at least one additional embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of apparatuses that include a rigid logo and a flexible backing, as well as methods of forming such apparatuses. As will be explained in greater detail below, embodiments of the present disclosure may include methods that include forming a rigid logo having a logo shape protruding from a rigid substrate, forming at least one aperture in a flexible backing (e.g., a leather backing), positioning the logo shape in the at least one aperture to protrude from a front surface of the flexible backing, and abutting a back surface of the flexible backing against the rigid substrate. Such methods may facilitate the fabrication of logo emblems and may improve apparatuses including logo emblems, for example, by making the logo emblems more solid and bonded more strongly with the flexible backing.

Features from any of the embodiments described herein may be used in combination with one another in accordance with the general principles described herein. These and other embodiments, features, and advantages will be more fully understood upon reading the following detailed description in conjunction with the accompanying drawings and claims.

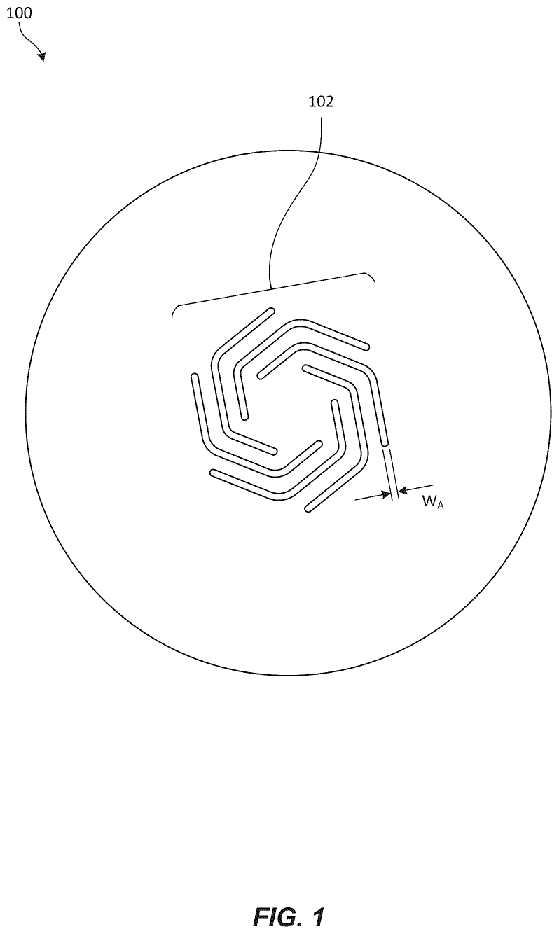

FIG. 1 is a plan view of a flexible backing 100 for an apparatus that includes a rigid logo, according to at least one embodiment of the present disclosure. For example, the apparatus to employ the flexible backing 100 may be a logo pendant or a logo portion of another article (e.g., a fashion accessory, an article of clothing, footwear, a hat, a backpack, a purse, a tote, a makeup bag, a briefcase, a keychain, a car part, an electronic device, a protective case or covering for an electronic device, a piece of furniture, a display case, etc.).

Relative to the rigid logo to be used with the flexible backing 100 (as will be explained below), the flexible backing 100 may provide a contrast in texture, hardness, color, sheen, or a combination thereof. By way of example and not limitation, the flexible backing 100 may be formed of a leather material (e.g., a real leather material or an artificial leather material), a woven fabric material, a non-woven fabric material, a flexible polymer material, a foam material, or a combination thereof.

In some examples, the flexible backing 100 may have a thickness (e.g., into the page from the perspective of FIG. 1) of about 3 mm or less, such as, but not limited to, 3 mm, 2 mm, 1 mm, or 0.5 mm.

The flexible backing 100 may include at least one aperture 102 therethrough that may be shaped and sized to correspond to the rigid logo to be used with the flexible backing 100. The configuration (e.g., shape, arrangement, size, etc.) of the at least one aperture 102 shown in FIG. 1 is illustrated by way of example. Other configurations are also included in the present disclosure. The at least one aperture 102 may be present in the flexible backing 100 to allow respective portions of the rigid logo to pass therethrough and protrude from a surface of the flexible backing 100.

The at least one aperture 102 may be formed in a variety of ways (e.g., depending on the material of the flexible backing 100), such as by die-punching, machining, slicing, machining, molding, laser ablation, three-dimensional (3D) printing, etc.

In some non-limiting examples, the at least one aperture 102 may include at least one aperture portion that has an aperture width W_{A} that is relatively narrow. For example, the aperture width W_{A} may be less than 2 mm, such as, but not limited to, 1.5 mm, 1 mm, 0.8 mm, 0.5 mm, or 0.2 mm.

The flexible backing 100 is illustrated in FIG. 1 as having a circular outer shape. However, the present disclosure is not so limited. In additional examples, the flexible backing 100 may have any outer shape, such as circular, elliptical, rectangular, polygonal, irregular, etc.

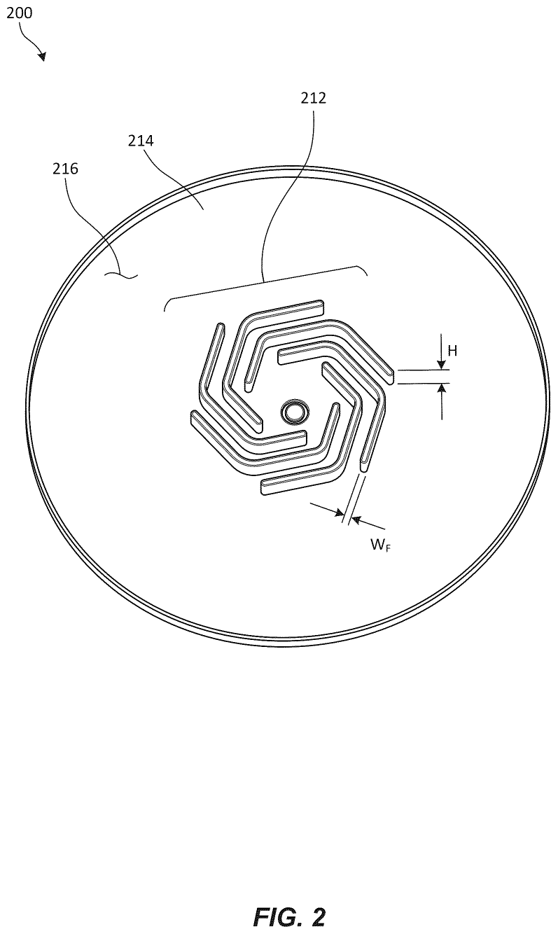

FIG. 2 is a perspective view of a rigid logo 200, according to at least one embodiment of the present disclosure. The rigid logo 200 may include a logo shape 212 protruding from a rigid substrate 214.

The logo shape 212 may have a configuration (e.g., shape and size) corresponding to the configuration of the at least one aperture 102 of the flexible backing 100 of FIG. 1, such that the logo shape 212 may be insertable into and through the at least one aperture 102. For example, the logo shape 212 may include at least one feature having a feature width W_{F} that corresponds to the aperture width W_{A} of the aperture portion of the at least one aperture 102. In some non-limiting examples, the feature width W_{F} may be less than 2 mm, such as 1.5 mm, 1 mm, 0.8 mm, 0.5 mm, or 0.2 mm.

In some examples, the logo shape 212 may have a height H protruding from the rigid substrate 214 that may be larger than a thickness of the flexible backing 100 (FIG. 1), such that the logo shape 212 may protrude past a front surface of the flexible backing 100. By way of example and not limitation, the height H of the logo shape 212 may be selected to protrude past the front surface of the flexible backing 100 by 0.2 mm, by 0.5 mm, by 1 mm, by 1.5 mm, by 2 mm, by 3 mm, by 4 mm, by 5 mm, or by more than 5 mm. In additional examples, the heigh H may be selected to be substantially flush with the front surface of the flexible backing 100.

In some examples, the terms “substantially” and “about” in reference to a given parameter, property, or condition, may refer to a degree that one skilled in the art would understand that the given parameter, property, or condition is met with a small degree of variance, such as within acceptable manufacturing tolerances and/or conventional measurement techniques. For example, a parameter that is substantially met may be at least about 90% met, at least about 95% met, at least about 99% met, or fully met.

In some embodiments, at least the logo shape 212 of the rigid logo 200 may be polished or otherwise finished, such as for improved aesthetics and/or feel.

The rigid substrate 214 may have a surface 216 against which a back surface of the flexible backing 100 may abut when assembled with the rigid logo 200. The surface 216 may be substantially planar, curved (e.g., concave, convex), stepped, or a combination thereof. In some embodiments, the surface 216 may be rough to improve bonding between the surface 216 and the flexible backing 100. For example, the surface 216 may be sanded, etched, ablated, powdered, painted, scratched, stamped, forged, molded, machined, or the like to induce surface roughness in the surface 216.

In some examples, the logo shape 212 and the rigid substrate 214 may be formed as a unitary, integral body of material. For example, the logo shape 212 and rigid substrate 214 may be simultaneously formed together, such as by a molding process (e.g., metal injection molding, polymer injection molding, etc.), a forging process, a machining process, a blanking process, etc.

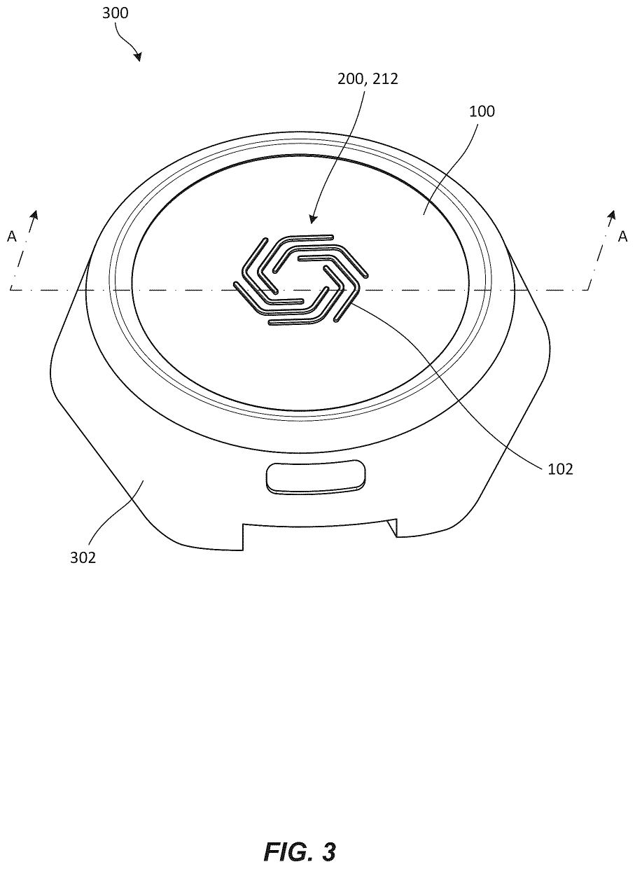

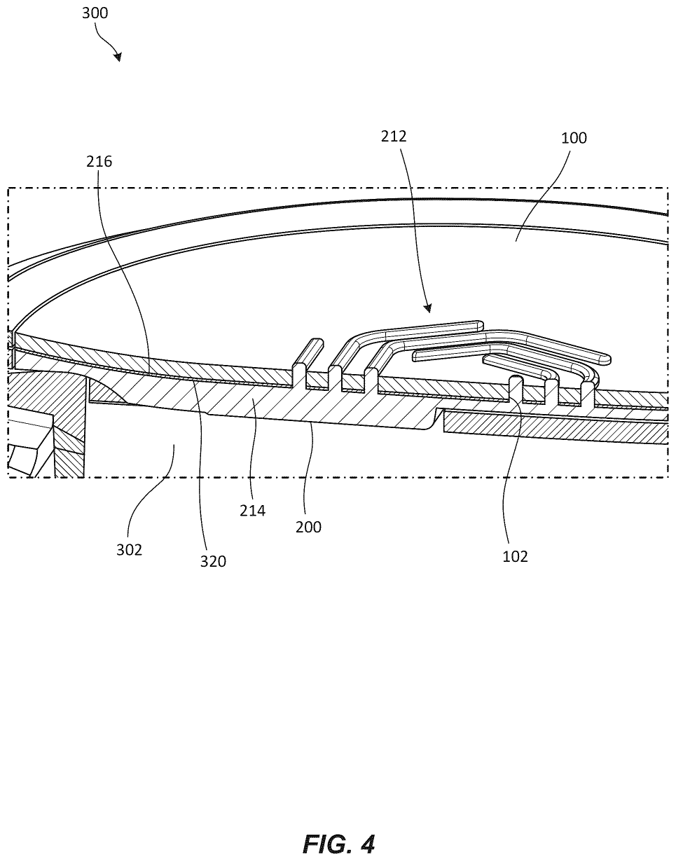

FIG. 3 is a perspective view of an apparatus 300 that includes a flexible backing 100 and a rigid logo 200, according to at least one embodiment of the present disclosure. FIG. 4 is a partial cross-sectional view of the apparatus 300 of FIG. 3, taken from line A-A of FIG. 3, according to at least one embodiment of the present disclosure.

As illustrated in FIGS. 3 and 4, the flexible backing 100 may be assembled with the rigid logo 200. For example, the logo shape 212 of the rigid logo 200 may be positioned to protrude through the at least one aperture 102 of the flexible backing 100 and above a front surface of the flexible backing 100. A back surface of the flexible backing 100 may be bonded to the surface 216 of the rigid substrate 214 of the rigid logo 200, such as with an adhesive 320 (FIG. 4). The rigid logo 200 and flexible backing 100 may be secured to a portion of the apparatus 300, such as a housing 302 or other substrate or structure of the apparatus 300. In some embodiments, the rigid logo 200 may be a part of the housing 302.

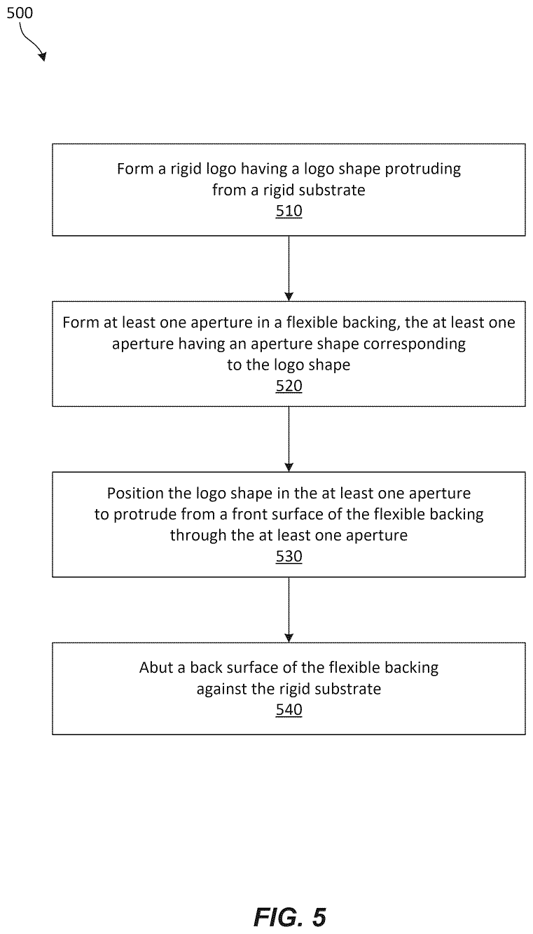

FIG. 5 is a flow diagram illustrating a method 500 of forming an apparatus, according to at least one embodiment of the present disclosure. At operation 510, a rigid logo may be formed to have a logo shape protruding from a rigid substrate. Operation 510 may be performed in a variety of ways. For example, the rigid logo may be formed of a metal or hard polymer material. In some embodiments, the rigid logo may be formed by injection molding, such as a metal injection molding (MIM) process. In some embodiments, the logo shape and the rigid substrate may be formed as a unitary, integral body of material. In some examples, the logo shape may be polished. In additional examples, a surface of the rigid substrate may be formed to have a rough surface, such as by etching, sanding, machining, scratching, stamping, etc. In further examples, the logo shape may be formed to have at least one feature with a feature width of less than 2 mm.

At operation 520, at least one aperture may be formed in a flexible backing, the at least one aperture having an aperture shape corresponding to the logo shape of the rigid logo. Operation 520 may be performed in a variety of ways. For example, the flexible backing may include a real or artificial leather material, a fabric material, or a flexible polymer material. The at least one aperture may be formed via a die-punching process, a machining process, or another suitable cutting process. In further examples, the at least one aperture may be formed to have at least one aperture portion with an aperture width of less than 2 mm.

At operation 530, the logo shape may be positioned in the at least one aperture to protrude from a front surface of the flexible backing through the at least one aperture.

At operation 540, a back surface of the flexible backing may be abutted against the rigid substrate. In some embodiments, the back surface of the flexible backing may additionally be bonded to the rigid substrate, such as with an adhesive.

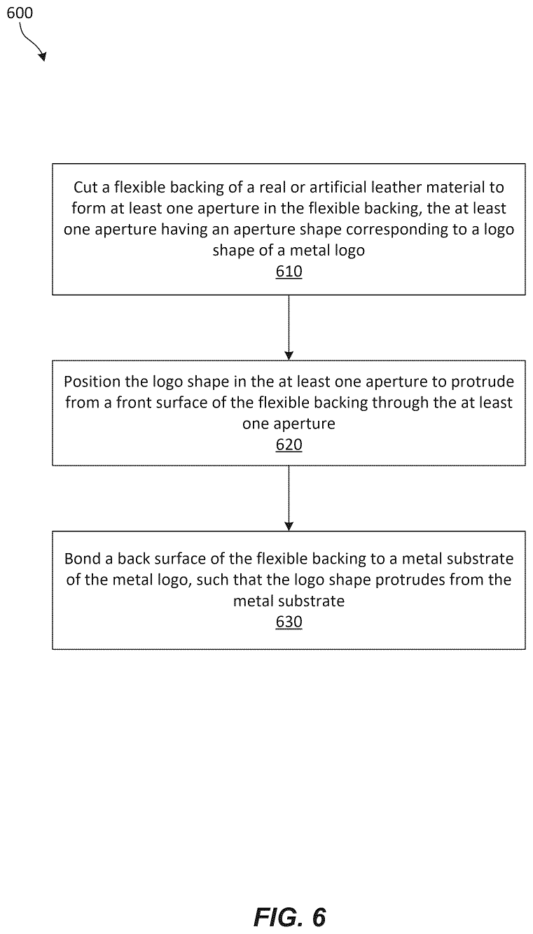

FIG. 6 is a flow diagram illustrating a method 600 of forming an apparatus, according to at least one additional embodiment of the present disclosure.

At operation 610, a flexible backing of a real or artificial leather material may be cut (e.g., die-punched, etc.) to form at least one aperture in the flexible backing, the at least one aperture having an aperture shape corresponding to a logo shape of a metal logo.

At operation 620, the logo shape may be positioned in the at least one aperture to protrude from a front surface of the flexible backing through the at least one aperture.

At operation 630, a back surface of the flexible backing may be bonded (e.g., adhered) to a metal substrate of the metal logo, such that the logo shape protrudes from the metal substrate.

In some embodiments associated with the method 600, a metal injection molding process may be performed to form the metal logo that has the logo shape protruding from the metal substrate. A surface of the metal substrate may be etched to improve the bonding between the back surface of the flexible backing and the metal substrate of the metal logo.

Accordingly, the present disclosure includes improved methods for forming an apparatus that includes a rigid logo and a flexible backing.

The following example embodiments are also included in the present disclosure.

Example 1. A method of forming an apparatus, the method including: forming a rigid logo having a logo shape protruding from a rigid substrate; forming at least one aperture in a flexible backing, the at least one aperture having an aperture shape corresponding to the logo shape; positioning the logo shape in the at least one aperture to protrude from a front surface of the flexible backing through the at least one aperture; and abutting a back surface of the flexible backing against the rigid substrate.

Example 2. The method of Example 1, wherein forming the rigid logo includes performing an injection molding process to form the rigid logo and the rigid substrate.

Example 3. The method of Example 1 or Example 2, further including, prior to positioning the logo shape in the at least one aperture, polishing the logo shape.

Example 4. The method of any one of Examples 1 through 3 further including bonding the back surface of the flexible backing to the rigid substrate with an adhesive.

Example 5. The method of Example 4, further including forming the rigid substrate to have a rough surface to improve the bonding between the back surface of the flexible backing and the rigid substrate.

Example 6. The method of any one of Examples 1 through 5, wherein the logo shape includes a metal material.

Example 7. The method of Example 6, wherein the rigid substrate includes the metal material.

Example 8. The method of any one of Examples 1 through 7, wherein the logo shape and the rigid substrate form a unitary, integral body of material.

Example 9. The method of any one of Examples 1 through 8, wherein the flexible backing includes a real or artificial leather material.

Example 10. The method of any one of Examples 1 through 9, wherein forming the at least one aperture in the flexible backing includes die-punching the flexible backing.

Example 11. The method of any one of Examples 1 through 10, wherein forming the rigid logo includes forming the logo shape to have at least one feature with a feature width of less than 2 mm and forming at least one aperture includes forming a corresponding aperture portion with an aperture width of less than 2 mm.

Example 12. A method of forming an apparatus, the method including: cutting a flexible backing of a real or artificial leather material to form at least one aperture in the flexible backing, the at least one aperture having an aperture shape corresponding to a logo shape of a metal logo; positioning the logo shape in the at least one aperture to protrude from a front surface of the flexible backing through the at least one aperture; and bonding a back surface of the flexible backing to a metal substrate of the metal logo, such that the logo shape protrudes from the metal substrate.

Example 13. The method of Example 12, further including performing a metal injection molding process to form the metal logo having the logo shape protruding from the metal substrate.

Example 14. The method of Example 12 or Example 13, further including etching a surface of the metal substrate to improve the bonding between the back surface of the flexible backing and the metal substrate.

Example 15. An apparatus, including: a rigid logo having a logo shape protruding from a rigid substrate; and a flexible backing including at least one aperture having an aperture shape corresponding to the logo shape, wherein the logo shape is positioned in the at least one aperture and protrudes from a front surface of the flexible backing through the at least one aperture, and a back surface of the flexible backing abuts against the rigid substrate.

Example 16. The apparatus of Example 15, wherein the back surface of the flexible backing is bonded to the rigid substrate with an adhesive.

Example 17. The apparatus of Example 15 or Example 16, wherein the rigid logo is formed of a metal material.

Example 18. The apparatus of any one of Examples 15 through 17, wherein the logo shape and the rigid substrate are portions of a unitary, integral body of material.

Example 19. The apparatus of any one of Examples 15 through 18, wherein the flexible backing includes a real or artificial leather material.

Example 20. The apparatus of any one of Examples 15 through 19, wherein the logo shape has at least one feature with a feature width of less than 2 mm and the at least one aperture includes a corresponding aperture portion with an aperture width of less than 2 mm.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method of forming an apparatus, the method comprising:
forming a rigid logo having a logo shape protruding from a rigid substrate;
forming at least one aperture in a flexible backing, the at least one aperture having an aperture shape corresponding to the logo shape;
positioning the logo shape in the at least one aperture to protrude from a front surface of the flexible backing through the at least one aperture; and
abutting a back surface of the flexible backing against the rigid substrate.

2. The method of claim 1, wherein forming the rigid logo comprises performing an injection molding process to form the rigid logo and the rigid substrate.

3. The method of claim 1, further comprising, prior to positioning the logo shape in the at least one aperture, polishing the logo shape.

4. The method of claim 1, further comprising bonding the back surface of the flexible backing to the rigid substrate with an adhesive.

5. The method of claim 4, further comprising forming the rigid substrate to have a rough surface to improve the bonding between the back surface of the flexible backing and the rigid substrate.

6. The method of claim 1, wherein the logo shape comprises a metal material.

7. The method of claim 6, wherein the rigid substrate comprises the metal material.

8. The method of claim 1, wherein the logo shape and the rigid substrate form a unitary, integral body of material.

9. The method of claim 1, wherein the flexible backing comprises a real or artificial leather material.

10. The method of claim 1, wherein forming the at least one aperture in the flexible backing comprises die-punching the flexible backing.

11. The method of claim 1, wherein forming the rigid logo comprises forming the logo shape to have at least one feature with a feature width of less than 2 mm and forming at least one aperture comprises forming a corresponding aperture portion with an aperture width of less than 2 mm.

12. A method of forming an apparatus, the method comprising:
cutting a flexible backing of a real or artificial leather material to form at least one aperture in the flexible backing, the at least one aperture having an aperture shape corresponding to a logo shape of a metal logo;
positioning the logo shape in the at least one aperture to protrude from a front surface of the flexible backing through the at least one aperture; and
bonding a back surface of the flexible backing to a metal substrate of the metal logo, such that the logo shape protrudes from the metal substrate.

13. The method of claim 12, further comprising performing a metal injection molding process to form the metal logo having the logo shape protruding from the metal substrate.

14. The method of claim 12, further comprising etching a surface of the metal substrate to improve the bonding between the back surface of the flexible backing and the metal substrate.

15. An apparatus, comprising:
a rigid logo having a logo shape protruding from a rigid substrate; and
a flexible backing including at least one aperture having an aperture shape corresponding to the logo shape,
wherein the logo shape is positioned in the at least one aperture and protrudes from a front surface of the flexible backing through the at least one aperture, and a back surface of the flexible backing abuts against the rigid substrate.

16. The apparatus of claim 15, wherein the back surface of the flexible backing is bonded to the rigid substrate with an adhesive.

17. The apparatus of claim 15, wherein the rigid logo is formed of a metal material.

18. The apparatus of claim 15, wherein the logo shape and the rigid substrate are portions of a unitary, integral body of material.

19. The apparatus of claim 15, wherein the flexible backing comprises a real or artificial leather material.

20. The apparatus of claim 15, wherein the logo shape has at least one feature with a feature width of less than 2 mm and the at least one aperture includes a corresponding aperture portion with an aperture width of less than 2 mm.
